(19) United States
(12) Patent Application Publication
(10) Pub. No.: US 2026/0225730 A1
(43) Pub. Date: Aug. 6, 2026

(54) SYSTEM AND METHOD FOR AUTONOMOUS LIFT AND DESCENSION ASSIST FOR ELECTRONIC VERTICAL TAKE OFF AND LANDING (EVTOL) VEHICLES

(71) Applicant: Rush Group Limited, L.L.C., Wayne, MI (US)

(72) Inventors: Nilanjan Kayal, Morgantown, WV (US); Steven Shultz, Brighton, MI (US)

(73) Assignee: Rush Group Limited, L.L.C., Wayne, MI (US)

(21) Appl. No.: 19/467,245

(22) Filed: Feb. 2, 2026

Related U.S. Application Data
(60) Provisional application No. 63/752,422, filed on Jan. 31, 2025.

(51) Int. Cl. B64F 1/04; B64F 1/00; B64F 1/02; B64F 1/35; B64U 10/13

(52) U.S. Cl. CPC B64F 1/04; B64F 1/0295; B64U 10/13; B64F 1/007; B64F 1/352

(57) ABSTRACT

An autonomous lift and descension assist platform for an electronic vertical take-off and landing (eVTOL) vehicle and a control strategy therefor are provided. The platform comprises a platform substrate, a plurality of mobility devices, a landing pad, a plurality of selectively removable battery packs, a plurality of onboard sensors, and an onboard computer or control unit configured to control the platform. The platform is configured to, during an eVTOL departure cycle, lift and accelerate the eVTOL to an initial altitude to begin more efficient cruise flight, provide support to an in-air eVTOL that is getting low on charge by autonomously ascending to meet the eVTOL at its cruise altitude such that the eVTOL may land thereon to preserve battery life, or during an eVTOL return cycle, autonomously ascend to meet the eVTOL at its cruise altitude and receive a payload from the eVTOL and/or control deceleration of the eVTOL.

### CROSS REFERENCE TO RELATED APPLICATIONS

This application claims the benefit of U.S. Provisional Application No. 63/752422, filed on Jan. 31, 2025, which is hereby incorporated by reference in its entirety.

### TECHNICAL FIELD

The disclosure relates generally to a system and method of autonomous lift and descension assist for electronic vertical take-off and landing (eVTOL) vehicles. More particularly, the disclosure relates to a lift assist and descend platform and related control strategy intended to lift or assist in the ascension of an eVTOL to cruise altitude, assist in eVTOL landings by meeting the eVTOL at cruising altitude and transporting the same to a parking position, or by receiving a payload deposited by an eVTOL at cruising altitude and transporting the payload to an unload position at ground level.

### BACKGROUND

Electric vertical takeoff and landing (eVTOL) aircrafts are being developed to serve a large market opportunity for personal transport, business transport, and payload delivery.

The range for an eVTOL is typically limited to twenty to two-hundred miles between charging events, with a reserve mandated by regulatory bodies to allow for contingencies such as emergency diversion from an intended landing site. Moreover, the operating phases of an eVTOL need varying amounts of power; some require the battery to discharge high amounts of current rapidly, reducing the distance the eVTOL can travel before its battery must be recharged. Studies have shown that there is an intense battery discharge rate at both take-off and landing resulting in eVTOL applications, namely, roughly twenty percent (20%) of battery capacity is required for attaining altitude, descent, and transitions, with a further twenty percent 20% of battery capacity required as reserve, leaving only approximately sixty percent (60%) of true battery capacity for transport and distance mobility operations.

In most cases, studies have shown that there is an intense battery discharge rate at both take-off (departure cycles) and landing (return cycles) resulting in eVTOL applications. Said another way, an eVTOL requires the battery to discharge high amounts of power rapidly during departure and return cycles, which thereby reduces the distance the eVTOL can travel before its battery must be recharged. Moreover, as eVTOLs increase in number and frequency of use for a variety of use cases, particularly in highly or densely populated areas such as major cities, airspace, like roadway traffic, is likely to become crowded and landing positions are more likely to become more difficult to obtain, like parking spaces. Queues for such landing spaces may become lengthy and time deterring.

As such, there is a need for an application that can limit the number of eVTOLs that require landing space, as well as an application that can assist eVTOLs with the battery depleting actions of take-off, i.e., assist in the elevation and acceleration of an eVTOL during a departure cycle, and landing, i.e., control deceleration of the eVTOL during return cycles, in an organized manner.

### SUMMARY

As detailed herein, electric vertical takeoff and landing (eVTOL) aircrafts are being developed to serve the personal transport, business transport, and payload delivery markets. However, densely populated areas require reduction in the number of eVTOLs attempting to park in a given area, organization of take-off and landing activities in concentrated areas, and eVTOLs traveling a longer distance likely require assistance in battery depleting actions of take-off, i.e., assist in the elevation and acceleration of an eVTOL during a departure cycle, and landing, i.e., control deceleration of the eVTOL during return cycles.

Accordingly, an autonomous lift and descension assist platform for an electronic vertical take-off and landing (eVTOL) vehicle and a method and control strategy for the same are provided. The autonomous lift and descension assist platform for an electronic vertical take-off and landing (eVTOL) vehicle comprises a platform substrate, a plurality of mobility devices, at least one landing pad for the eVTOL, a plurality of selectively removable battery packs, a plurality of onboard sensors, and an onboard computer or control unit, in fluid communication with at least the plurality of mobility devices, the onboard sensors, the plurality of battery packs, as well as the eVTOL vehicle, via the respective onboard computer of the eVTOL.

More particularly, the autonomous lift and descension assist platform comprises a platform substrate defining an exterior perimeter and having a body defined within the exterior perimeter of the platform substrate. The platform substrate body further defines a top surface and a bottom surface that are radially spaced apart by a platform thickness, and an outer edge disposed on the exterior perimeter. At least one landing pad, configured to receive the eVTOL thereon, is further disposed in contact with the top surface of the platform substrate.

A plurality of extension portions each of which is attached to the platform substrate at the outer edge of the platform substrate, wherein each extension portion is comprised to receive a mobility device thereon. The platform further comprises a plurality of onboard sensors disposed in a plurality of housings operatively anchored to the top surface of the platform substrate.

A plurality of selectively removable battery packs disposed in contact with the bottom surface of the platform substrate and disposed beneath the landing pad, such that the thickness of the platform substrate extends from the landing pad to the respective battery packs. The battery packs are configured to power the platform generally, including but not limited to the mobility devices, onboard sensors, a control unit or onboard computer, and any additional electronics.

The autonomous lift and descension assist platform further comprises a control unit or onboard computer having a non-transitory computer readable medium that stores a set of computer executable instructions and at least one processor configured to execute the computer executable instructions embodied on the non-transitory computer readable medium, wherein the computer executable instructions cause the control unit and the processor to send signals to one or more of the plurality of mobility devices, the onboard sensors, the plurality of battery packs, as well as the eVTOL vehicle, via the respective onboard computer of the eVTOL, to control the platform.

When executed, the computer executable instructions cause the processor to facilitate completion of the control strategy detailed in the method of the present disclosure, such that the present method and control strategy comprises at least the following steps: receiving a plurality of requests from a plurality of eVTOLs to land on the landing pad of the platform; prioritizing the requests received and determining a priority of the eVTOLs 10 based on number of available platforms, eVTOL characteristics, and environmental characteristics; and scheduling a landing time for the eVTOL. The control strategy is intended to be dynamic, such that upon receipt of additional requests, the system re-determines the priority of the eVTOLs based on, the number of available platforms, eVTOL characteristics, and environmental characteristics; and may optionally reschedule the landing time for the eVTOL.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The operation of the invention may be better understood by reference to the detailed description taken in connection with the following illustrations, wherein:

FIG. 1 is a schematic drawing of an example autonomous lift and descension assist platform with an example eVTOL disposed thereon.

FIG. 2A is a schematic drawing of a departure cycle for the autonomous lift and descension assist platform deployed during an eVTOL take-off event.

FIG. 2B is a schematic drawing of a return cycle for the autonomous lift and descension assist platform deployed during an eVTOL landing event.

FIG. 3 is a schematic top perspective view of the autonomous lift and descension assist platform of the present disclosure.

FIG. 4 is a schematic top view of the autonomous lift and descension assist platform of the present disclosure.

FIG. 5A is another schematic top perspective view of the autonomous lift and descension assist platform of the present disclosure.

FIG. 5B is a schematic exploded view of the autonomous lift and descension assist platform as shown in FIG. 5A.

FIG. 6 is a schematic front view of the autonomous lift and descension assist platform of the present disclosure.

FIG. 7 is a schematic side view of the autonomous lift and descension assist platform of the present disclosure.

FIG. 8A is schematic bottom perspective view of the autonomous lift and descension assist platform of the present disclosure.

FIG. 8B is a schematic exploded view of the autonomous lift and descension assist platform as shown in FIG. 8A.

FIG. 9 is a schematic bottom view of the autonomous lift and descension assist platform of the present disclosure.

FIG. 10 is an example diagram of the prospective control logic of the present disclosure shown in flow chart form in FIG. 11.

FIG. 11 is an example flow chart detailing the steps and sub-steps of the present method and control logic strategy for the autonomous lift and descension assist platform of the present disclosure.

### DETAILED DESCRIPTION

While the present disclosure may be described with respect to specific applications or industries, those skilled in the art will recognize the broader applicability of the disclosure. The terms “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second” are illustrative only and are not intended to limit the scope of the disclosure in any way.

The term “longitudinal”, as used throughout this detailed description and in the claims, refers to a direction extending a length of a component. In some cases, a component may be identified with a longitudinal axis as well as a forward and rearward longitudinal direction along that axis. The longitudinal direction or axis may also be referred to as an anterior-posterior direction or axis.

The term “transverse”, as used throughout this detailed description and in the claims, refers to a direction extending a width of a component. The transverse direction or axis may also be referred to as a lateral direction or axis or a mediolateral direction or axis.

The term “vertical”, as used throughout this detailed description and in the claims, refers to a direction generally perpendicular to both the lateral and longitudinal directions.

In addition, the term “proximal” refers to a direction that is nearer a center of a component. Likewise, the term “distal” refers to a relative position that is further away from a center of the component. Thus, the terms proximal and distal may be understood to provide generally opposing terms to describe relative spatial positions.

The term “Databases or data stores” as described herein may include various kinds of mechanisms for storing, accessing, and retrieving various kinds of data, including a hierarchical database, a set of files in a file system, an application database in a proprietary format, object-relational database management system (ORDMBS), a relational database management system (RDBMS), a non-relational database management system, a look-up table, etc.

The term “non-transitory computer readable medium” as described herein may include any medium that participates in providing data (e.g., instructions), which may be read by a computer or control unit. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read, as well as networked versions of the same.

The term “computer-executable instructions” may include instructions compiled or interpreted from computer programs, software code, or algorithms created using a variety of programming languages and/or technologies, including, without limitation, and either alone or in combination, Java™, C, C++, Visual Basic, Java Script, Perl, HTML, Python, Julia, or other suitable programming languages. In general, a processor (e.g., a microprocessor) receives instructions, e.g., from a memory on a computer-readable medium, and executes these instructions, thereby performing one or more processes. Such instructions and other data may be stored and transmitted using a variety of computer-readable media. It is appreciated that software modules can be callable from other modules or from themselves, and/or can be invoked in response to detected events or interrupts. The modules, computer executable instructions, and/or computing device functionality described herein are preferably implemented as software modules but can be represented in hardware or firmware. Generally, the modules, computer executable instructions, and/or computing device functionality described herein refer to logical modules that can be combined with other modules or divided into sub-modules despite their physical organization or storage.

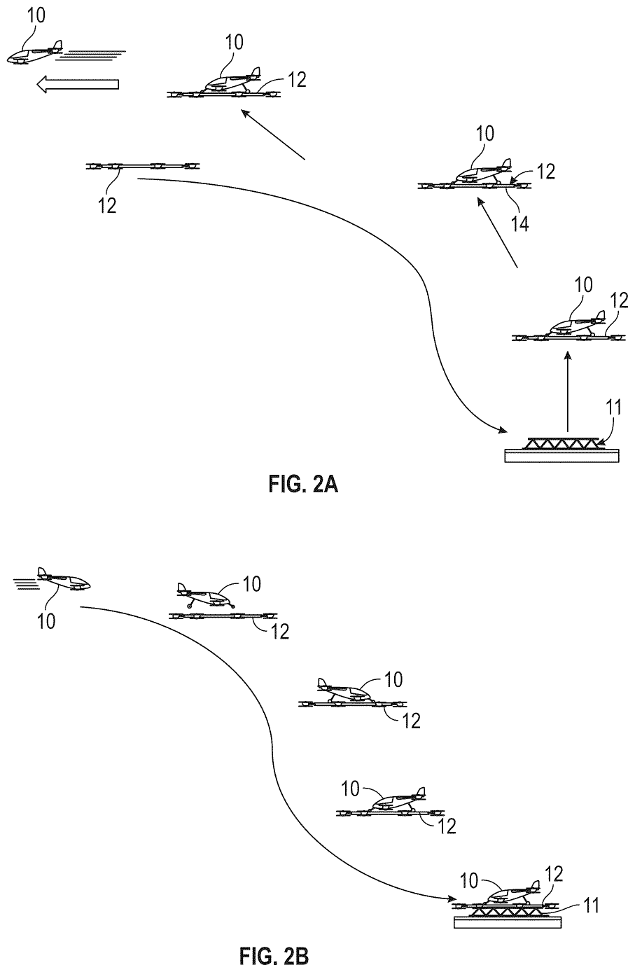

Referring to the drawings, wherein like reference numerals refer to like components throughout the several views, an autonomous lift and descension assist platform 12 for an electronic vertical take-off and landing (eVTOL) vehicle 10 and a method and control strategy 100 for the same are provided. In a general sense, the platform 12 in operation in accordance with the method 100 is configured to assist in the elevation and acceleration of an eVTOL 10 during a departure cycle (FIG. 2A), i.e., upon take-off, as well as control deceleration of the eVTOL during a return cycle (FIG. 2B), i.e., when landing, in order to reduce the power consumption and reduce battery depletion during such departure and return cycles to ultimately increase the distance the eVTOL 10 can travel before its battery 42 must be recharged. Alternatively, the platform 12 may be configured to meet an eVTOL 10 at cruise altitude, allow the eVTOL 10 to land upon the platform 12 and deposit a payload, and return the payload to ground or street level. In short, the platform 12 is configured to: 1) during an eVTOL 10 departure cycle (FIG. 2A), lift and accelerate the eVTOL 10, at a user acceptable rate, to an initial altitude to begin more efficient cruise flight; 2) provide support to an in-air eVTOL 10, that is getting low on charge or receive a payload from an eVTOL, by autonomously ascending to meet the eVTOL at its cruise altitude for temporary landing; and/or 3) during an eVTOL return cycle (FIG. 2B), autonomously ascend to meet the eVTOL 10 at its cruise altitude and control deceleration of the eVTOL to a landing pad 11 or parking location.

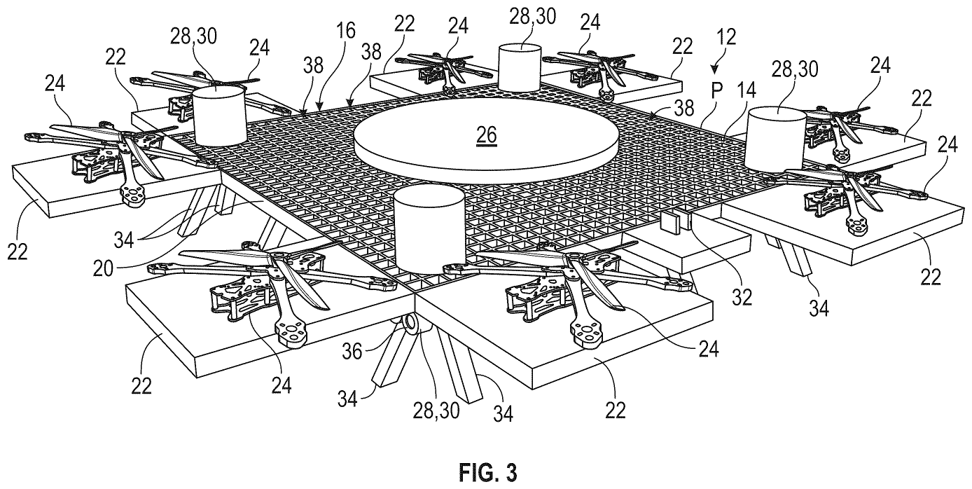

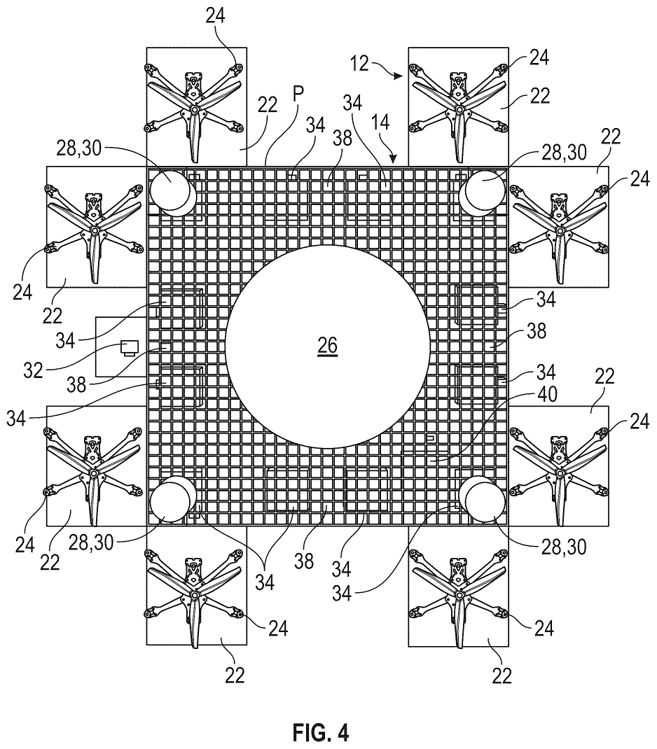

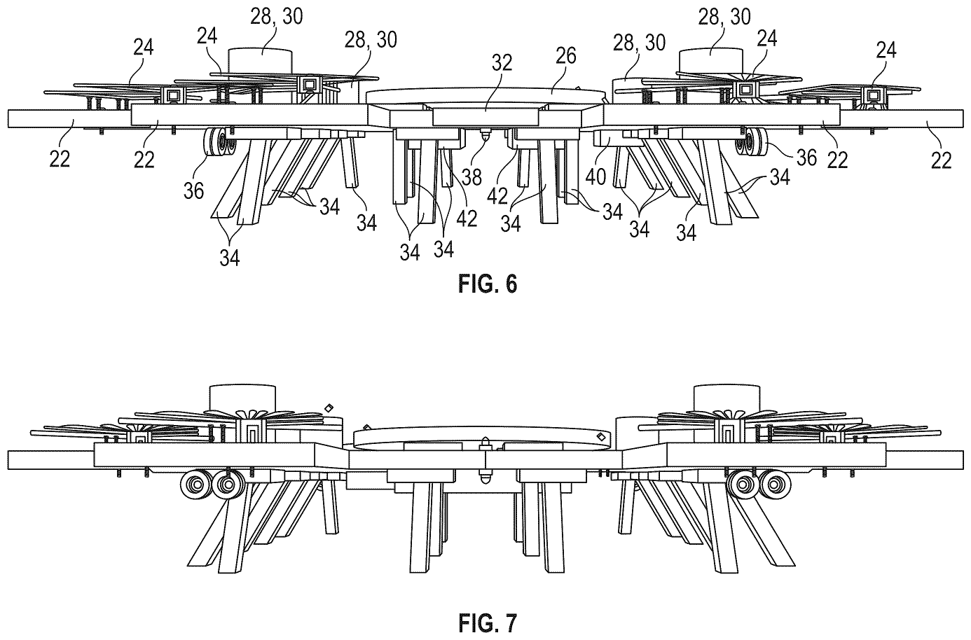

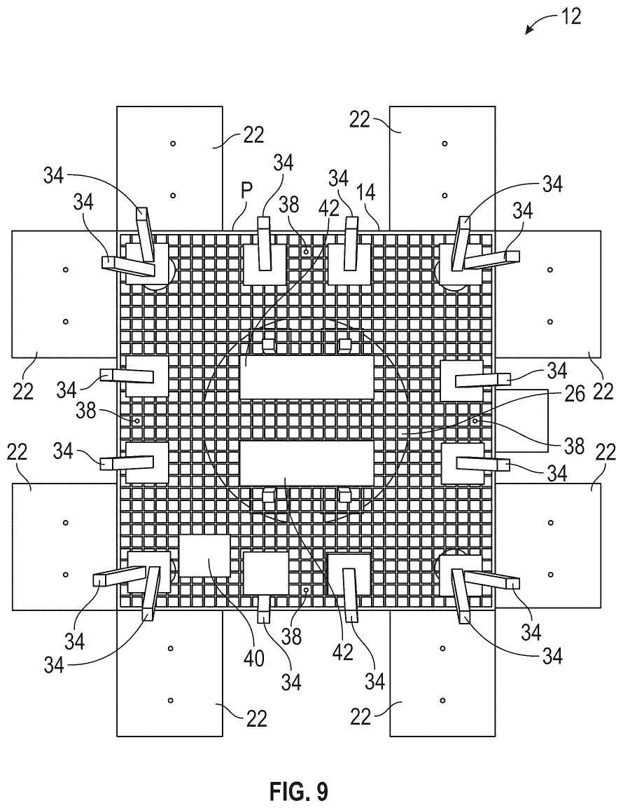

More particularly, referring generally to FIGS. 3-9, the autonomous lift and descension assist platform 12 for an electronic vertical take-off and landing (eVTOL) vehicle 10 may comprise a platform substrate 14, a plurality of extension portions 22, a plurality of mobility devices 24, a landing pad 26 for the eVTOL 10, which may have capabilities to conductively charge the eVTOL battery, a plurality of selectively removable battery packs 42, a conductive charging pad 40 for charging the onboard batteries 42, a plurality of onboard sensors 28, a plurality of light elements 38, a plurality of structural supports 34, a plurality of movement elements 36, and an onboard computer or control unit, in fluid communication with at least the plurality of mobility devices 24, the onboard sensors 28, the plurality of battery packs 42, as well as onboard computer of the respective eVTOL 10.

The platform substrate 14 defines an exterior perimeter P and comprises a body defined within the exterior perimeter P. The body 14 may further define an outer edge disposed on the exterior perimeter P, a top surface 16 and a bottom surface 18 that are radially spaced apart by a platform thickness 20. The platform substrate 14 may be comprised of a mesh grate formed of an aluminum material and coated with a carbon fiber reinforced polyamide. The mesh grate structure allows for pass through of water as well as to reduce wind drag on the platform 12 during a departure cycle (FIG. 2A) and a return cycle (FIG. 2B).

The platform substrate may also have a length of from about seventy-five (75) feet to about one-hundred and fifteen (115) feet and a width of from about seventy-five (75) feet to about one-hundred and fifteen (115) feet. In one, example the platform substrate 14 has a length of about ninety (90) feet and a width of about ninety (90) feet. The platform substrate thickness 20 is from about two (2) feet to about three (3) feet.

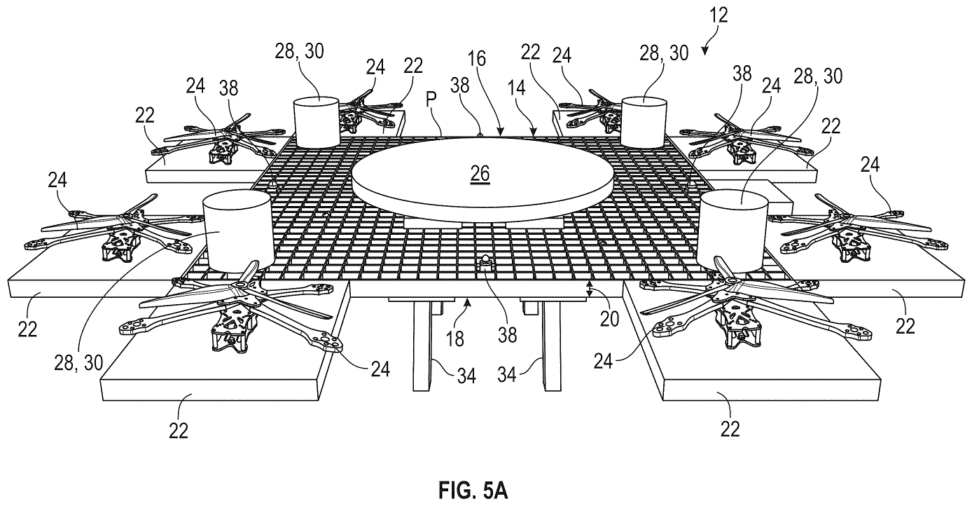

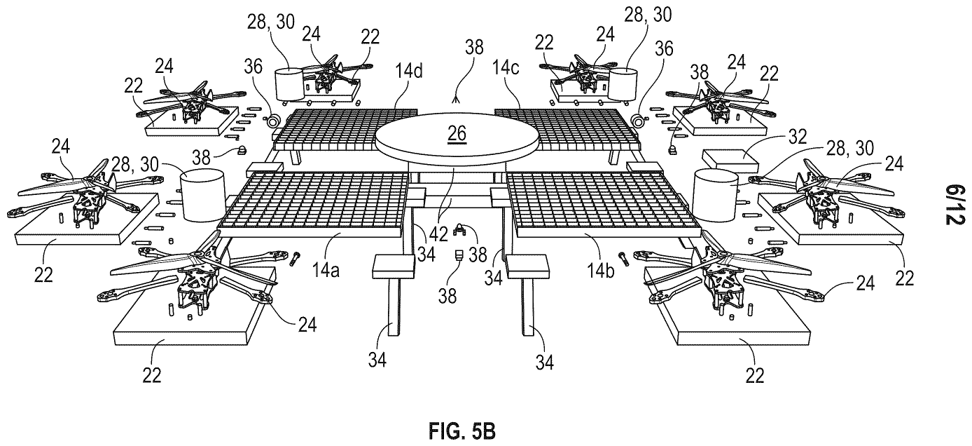

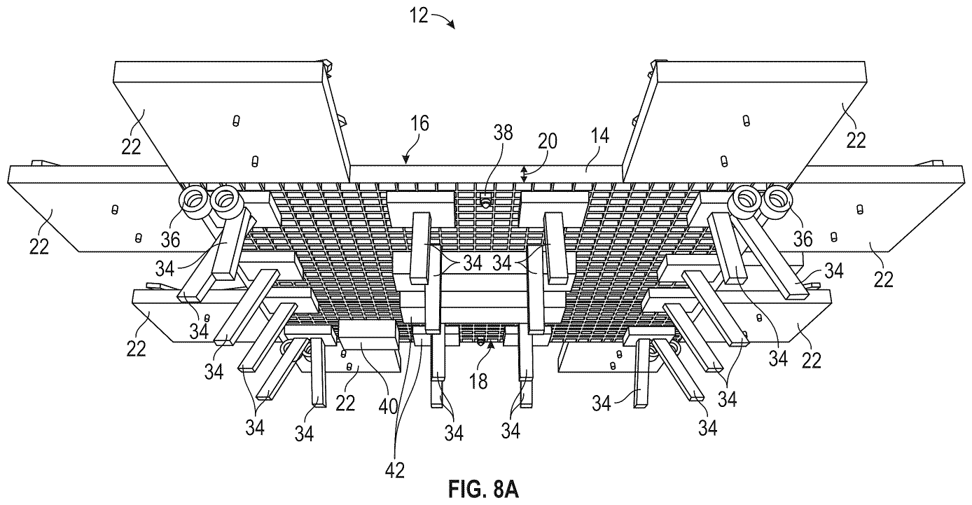

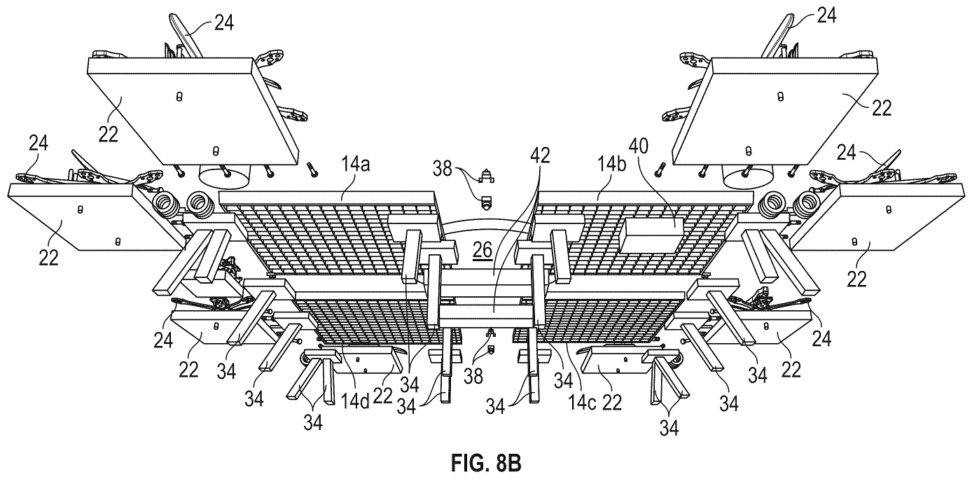

As shown in FIGS. 5B and 8B, in one example embodiment, the platform substrate 14 may comprise a plurality of component portions 14a, 14b, 14c, 14d, and for example, a first portion 14a, a second portion 14b, a third portion 14c, and a fourth portion 14d. A platform substrate 14 capable of breaking down into the component portions allows for ease of transport (on a standard fifty-two-foot trailer semi-trailer), assembly, and installation. In such an example, each of the first portion 14a, the second portion 14b, the third portion 14c, and the fourth portion 14d are formed in a square shape having a width of from about thirty-five (35) feet to about sixty (60) feet and a length of from about thirty-five (35) feet to about sixty (60) feet and a length. In one example, each of the first portion 14a, the second portion 14b, the third portion 14c, and the fourth portion 14d are formed in a square shape having a width of about forty-five (45) feet and a length about forty-five (45) feet.

The platform 14 may further comprise a plurality of lighting elements 38. The lighting elements 38 may each comprise a top lighting element, a bottom lighting element, and an intermediate body, such that the intermediate body is disposed within the thickness of the platform 20, and the top lighting element extends from the intermediate body above the top surface 16 of the platform 14 and the bottom lighting element extends from the intermediate body below the bottom surface 18 of the platform 14.

The platform 14 may further comprise a landing pad 26 configured to receive the eVTOL 10 thereon. The landing pad 26 may be disposed in contact with the top surface 16 of the platform substrate 14. The landing pad 26 may define an anti-skid landing zone covered in a polymeric or elastomeric material such as rubber or another suitable material having suitable friction characteristics. The landing pad 26 may also be equipped to inductively or conductively charge the battery of an eVTOL 10 that lands thereon, via the battery packs 42.

The platform 14 may further comprise plurality of extension portions 22 that extend from the outer edge of the platform substrate 14 disposed on the perimeter P and are configured to receive or house thereon a plurality of mobility devices 24. In one example, one mobility device 24 is disposed on each extension portion 22. The mobility devices 24 collectively are capable of powering the platform 12 to ascend and descend as instructed. Each mobility device 24 may comprise an unmanned aerial vehicle (UAV) or a drone, an adaptive ducted fan, or another suitable mobility device.

The platform 14 may be further equipped with a variety of onboard sensors 28. The plurality of onboard sensors 28 may comprise at least one LIDAR sensor, a GPS unit, an accelerometer, an altitude sensor, an air pressure sensor, a battery temperature sensor, a positioning sensor, at least one gyroscopic sensor, and a vision system. The onboard sensors 28 may be packaged in housing disposed on the top surface of the platform 14 or otherwise interconnected with the respective platform portions. Integrated vision systems like cameras and depth sensors assist the platform 12 recognize and guide the eVTOL 10 for precision landing. In one example, the control unit 32 may receive signals from the onboard sensors 28 and integrated vision systems that allow the control unit to conduct and control precision positioning and alignment, active stabilization and balancing, wind and weather compensation, obstacle detection and avoidance, platform guidance and docking control, load management and distribution, energy efficiency and power management.

The mobility devices 24 and the onboard sensors 28 may be operatively and electrically connected to a plurality of selectively removable battery packs 42. The battery packs 42 may comprise large, high voltage battery cells. The battery packs 42 may be disposed in a fireproof housing and such a housing may be disposed in contact with the bottom surface 18 of the platform substrate 14, such that the platform thickness 20 extends from the battery 42 housing to the landing pad 26.

The platform 14 may also comprise a conductive charging pad 40 configured to charge the battery packs 42 when the platform 14 is grounded or seats on a landing stand 11. Each landing stand 11 may comprise a damper mounted to bottom of the respective stand 11 to maintain low profile while giving a cushioned landing for the platform 14 following a return cycle (FIG. 2B).

Optionally, in some example embodiments the platform 14 may further comprise a plurality of parachutes 30, a plurality of support structures 34, and a plurality of movement elements 36. The plurality of parachutes 30 may be packaged in a housing, the housing being disposed on the top surface 16 of the platform substrate 14. The plurality of support structures 24 may be disposed in contact with and extend from the bottom surface 18 of the platform substrate 14. The plurality of movement elements 36 may be disposed in contact with the bottom surface 18 of the platform substrate 14 and facilitate loading, unloading, transport, and installation of the platform 12.

Finally, platform 12 further comprises a control unit 32 or onboard computer having a non-transitory computer readable medium that stores a set of computer executable instructions and at least one processor configured to execute the computer executable instructions embodied on the non-transitory computer readable medium.

The platforms 12 via the control unit 32 may be in fluid communication with a system server platform 50, which also comprises a computer readable memory and a processor configured to execute a set of computer executable instructions. Written on the computer readable memory of the system server platform 50 is at least one storage Database, a knowledge Database including foundation models, and at least one algorithm. The system server platform 50 may also include a variety of other modules written or stored within the computer readable memory. As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions.

The storage Database is configured to store a compilation of targeted information, including historic weather for platform locales, typical platform and eVTOL traffic in a geographic region of a platform 12, and other general locational information that may be compiled external content from designated sources by direct upload or via an automated information gathering device programmed to retrieve information from the predefined source locations. The storage Database of external or third-party content may be populated in part by automated information gathering device such as content crawlers. The content crawlers may comprise internet bots that are configured to seek out targeted information and retrieve the information to be organized and processed. The content crawlers may be specifically configured to seek out content from designated sources. For example, each content crawler may be programmed or configured to seek out and retrieve information from a specific predetermined or preprogrammed source.

The knowledge Database is also written on and stored to the non-transitory computer readable medium of the system server 50 and contains known information from the storage Database as well as additional learned information from the respective platforms 12. The knowledge Database 20 may comprise information loaded or obtained via the respective platforms 12 over periods of operation, i.e., relevant data for the specific platform 12 based on known parameters and geographical location of the platform 12, e.g., location, size, battery life, average travel speed, and platform use case (passenger or payload delivery), amongst other information. Said another way, the knowledge base is a comprehensive repository of information made up of a variety of stored content.

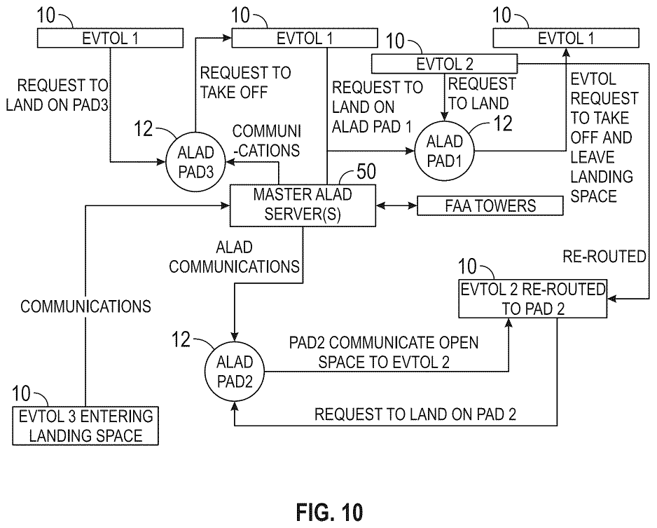

As such, as detailed further in the diagram of FIG. 10, the platforms 12 may be capable of vehicle 10 to platform 12 communications (sending a receipt of signals between) as well as platform 12 to system server 50 communications (sending a receipt of signals between) that effectuate real-time data exchange between the eVTOL 10, the platform 12, and the system server 50 to coordinate actions during critical phases like lift-off in a departure cycle (FIG. 2A), deposit of a payload at cruise altitude, and landing in a return cycle (FIG. 2B), such as flight path adjustments, collision avoidance, duplicate landings on a single platform 12, emergency landings, and the like. In fact, such vehicle 10 to platform 12, vehicle 10 to system server 50, and platform to system server 50 communications are paramount for the execution of the control strategy 100.

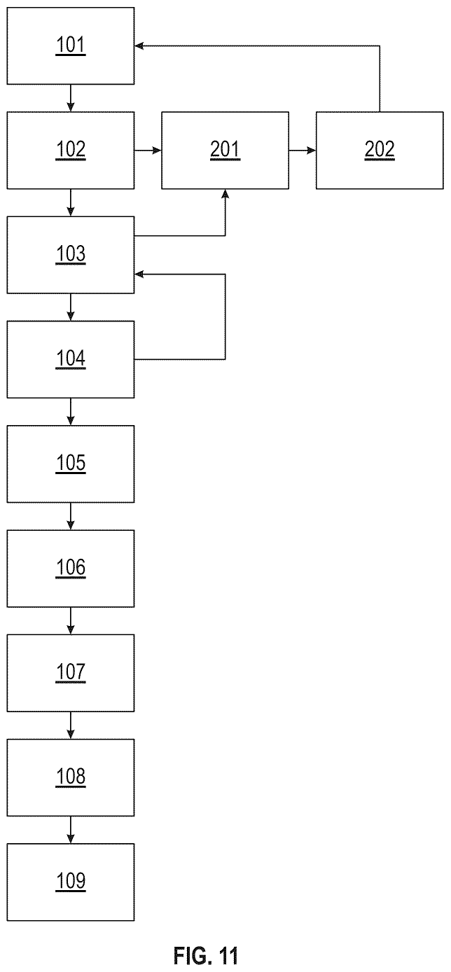

When executed, the control strategy detailed in the method 100 of the present disclosure as shown in FIGS. 10 and 11, comprises the following steps.

At step 101, the control unit 32 of a respective platform 12 receives a request from one or more eVTOLs 10 to land on the landing pad 26 of the platform 12.

At step 102, the control unit evaluates the real-time environmental conditions (wind, precipitation, or other environmental turbulence inducing conditions) and eVTOL characteristics and determines if the platform 12 is a viable landing pad for the respective eVTOL. When evaluating eVTOL characteristics, the control unit 32 receives bibliographic information from the onboard computer of the respective eVTOL 10 including vehicle size and weight, type of flight (passenger or payload delivery), eVTOL battery level, amongst other factors.

For example, if requesting eVTOLs 10 require charging or battery replacement, the control unit 32 factors in the availability of charging stations or energy supply to allocate eVTOLs 10 that need power to a platform 12 with charging capability. If certain requesting eVTOLs 10 require maintenance or servicing, the control unit 32 allocates such eVTOLs 10 to platforms 12 with access to ground crew or specialized resources for repairs or inspection. If the requesting eVTOL 10 is a payload delivery vehicle, that need only deposit a payload with the platform 12 at cruising altitude for local delivery there must be deposit or delivery space available and the platform 12 must be within a defined radius of the delivery location at ground level.

If it is determined that the respective platform 12 is not a viable landing pad for the respective eVTOL 10, then at Step 201, the platform 12 will refuse the eVTOL and notify the system server 50 that the requesting eVTOL 10 must be rerouted to an alternate platform. At step 202, the system server 50 will then send a signal to the refused eVTOL 10 and reroute the same to another platform that is a viable landing pad for the respective eVTOL 10. In this way, Steps 101-102 of the present method will repeat at the alternate platform 12, i.e., the respective eVTOL 10 will send a signal or request to the alternate platform 12 to land on the landing pad 26 of the platform 12 and the control unit evaluates the real-time environmental conditions (wind, precipitation, or other environmental turbulence inducing conditions) and eVTOL characteristics and determines if the platform 12 is a viable landing pad for the respective eVTOL.

Once a respective platform 12 is acknowledged as a viable landing pad for the respective eVTOL 10 in an iteration of Step 102, next at Step 103, the control unit organizes and arranges a landing queue for the respective platform 12. In this way, the control unit 32 prioritizes the requests received from respective eVTOLS 10 for which the respective platform is a viable landing pad and determines a priority based on a variety of factors, including but not limited to the number of nearby available platforms 12, real-time environmental conditions, and eVTOL characteristics (size, weight, type of flight (passenger or payload delivery), and eVTOL battery level).

Based on the detailed considerations for determining a priority of a respective eVTOL 10, at Step 104, the control unit 32 will schedule a landing time for respective eVTOLs 10 to land on the landing pad 26 of a designated platform 12.

The control unit 32, however, is designed to have a dynamic queue system, such that the system will dynamically adjust the landing queue based on real-time events, such as new incoming eVTOLs 10, delays, cancellations, or emergency landings. As such, after scheduling a landing at step 104, the control strategy 100 returns to step 103, wherein the control unit 32 may re-determine the priority of the at least one eVTOL 10 based on additional requests to land on the landing pad 26 of the platform 12 from other eVTOLs 10, the number of available platforms 12, eVTOL 10 characteristics, and environmental characteristics, and upon returning to step 104, reschedule the landing time for the eVTOL 10. Alternatively, If the queue for any one platform 12 reaches a threshold number of eVTOLs 10, the control unit 32 may determine that the respective platform 12 is not a viable landing pad for the respective eVTOL 10, given the delay and therefore, return to Step 201, wherein the control unit 32 refuses the eVTOL 10 and notifies the system server 50 that the requesting eVTOL 10 must be rerouted to an alternate platform 12. The control strategy then continues through step 202, wherein the system server 50 will then send a signal to the refused eVTOL 10 and reroute the same to another platform 12 that is a viable landing pad for the respective eVTOL 10. In this way, Steps 101-102 of the present method will repeat at the alternate platform 12, i.e., the respective eVTOL 10 will send a signal or request to the alternate platform 12 to land on the landing pad 26 of the platform 12 and the control unit evaluates the real-time environmental conditions (wind, precipitation, or other environmental turbulence inducing conditions) and eVTOL characteristics and determines if the platform 12 is a viable landing pad for the respective eVTOL.

As such, the system will be able to preemptively move lower-priority eVTOLs to secondary platforms 12 or reschedule their landings to later times if higher-priority vehicles need immediate access. eVTOLs with having safety considerations, will be prioritized in the queue, eVTOLs 10 comprising deliveries, that need only deposit a payload with the platform 12 at cruising altitude for local delivery are likely to be placed lower in the queue than other passenger carrying eVTOLs 10 or eVTOLs requiring immediate charging or maintenance. In this way, the control unit 32 will assess the type of flight that is associated with a requesting eVTOL 10. Passenger eVTOLs, cargo eVTOLs, and specialized vehicles (e.g., medical airlifts) may have different landing and resource requirements. eVTOLs 10 with low battery levels with be prioritized for immediate landing on platforms 12 with charging infrastructure, and eVTOLs with maintenance requirements will be prioritized for immediate landing on platforms with access to ground crew or specialized resources for repairs or inspection.

Once an eVTOL 10 reaches this top position in the queue for a particular platform 12, at Step 105 the control unit 32 shall send a signal to the onboard computer of the respective eVTOL 10 clearing the same for landing. The eVTOL 10 shall then respond with a signal that reflects the eVTOL characteristics (size, weight, type of flight (passenger or payload delivery), and eVTOL battery level)).

In preparing for landing of a respective eVTOL 10 on a respective platform 12, the control unit 32 evaluates the eVTOL characteristics and the real time environmental characteristics (wind, precipitation, or other environmental turbulence inducing conditions) pulled from the onboard sensors 28 and/or the knowledge Database of the Server System 50. In some example embodiments, the platform 12 will assist the eVTOL in landing, i.e., control deceleration of the eVTOL during return cycles, in an organized manner.

When evaluating real-time environmental characteristics, the control unit 32 receives signals from the plurality of onboard sensors 28 comprising at least one LIDAR sensor, a GPS unit, an accelerometer, an altitude sensor, an air pressure sensor, a battery temperature sensor, a positioning sensor, at least one gyroscopic sensor, and a vision system, evaluates the sensor outputs, and thereby adjusts the landing positions to eVTOLs 10 based on wind speed, temperature, precipitation, and other weather conditions in real time, to minimize the risk of crosswinds, turbulence, or icy surfaces affecting landings. In low-visibility conditions, the control unit 32 will space out landing schedules or allocate eVTOLs 10 to platforms 12 that are better equipped with visual or radar-based guidance systems.

With respect to precision positioning and alignment, the platform 12 may use real-time GPS, LiDAR, or vision-based systems to ensure the platform 12 and eVTOL 10 are precisely aligned for takeoff or landing, and platform 12 will continuously adjust its positioning during the departure cycles and landing cycles, reducing errors due to environmental factors like wind. With respect to wind and weather compensation the onboard sensors 28 will detect environmental conditions like wind, rain, or turbulence, such that the control unit 32 may execute instructions to make real-time adjustments to throttle, tilt, and the like to stabilize the platform 14 and the vehicle 10 during departure and return cycles.

With respect to active stabilization and balancing the platform 12 will use gyroscopes and advanced feedback control systems to stabilize the platform 12 against vibrations, tilting, or external forces, and the platform 12 will continuously monitor the eVTOL's 10 balance and adjust its own movements or tilt to match changes in eVTOL 10 weight distribution during load/unload operations. The platform 12 will be able to detect uneven weight distribution during loading or unloading and adjust the eVTOL's 10 balance dynamically to prevent tipping or unstable lift-off. In the event of an emergency, the platform 12 will have an emergency override mode where it guides the eVTOL 10 to a safe landing with minimal impact. Moreover, with the use of advanced radar, LiDAR, or ultrasonic sensors the platform 12 will also detect any objects in the flight path and automatically adjust descent or ascent trajectories. The platform 12 may also employ machine learning or adaptive algorithms that learn from previous departure and return cycles (stored in the knowledge Database of the server system 50), improving the response of the platform 12 to new environmental factors.

After landing on a respective platform 12, an eVTOL 10 must then via its onboard computer, at step 106, submit a request to the platform control unit 32 to take-off. Upon receipt of the request for take-off, the control unit 32 submits the request for take-off to the server system 50 at Step 107. At step 108, the server system 50 submits a plurality of take-off criteria to the platform 12 control unit 32, including but not limited to, time, approved flight path and trajectory, take-off altitude amongst other considerations.

At step 109, the platform 12 orients itself in accordance with the take-off instructions and signals the eVTOL 10 to take off in accordance therewith. In some instances, the platform 12 will assist in the elevation and acceleration of an eVTOL 10 during a departure cycle.

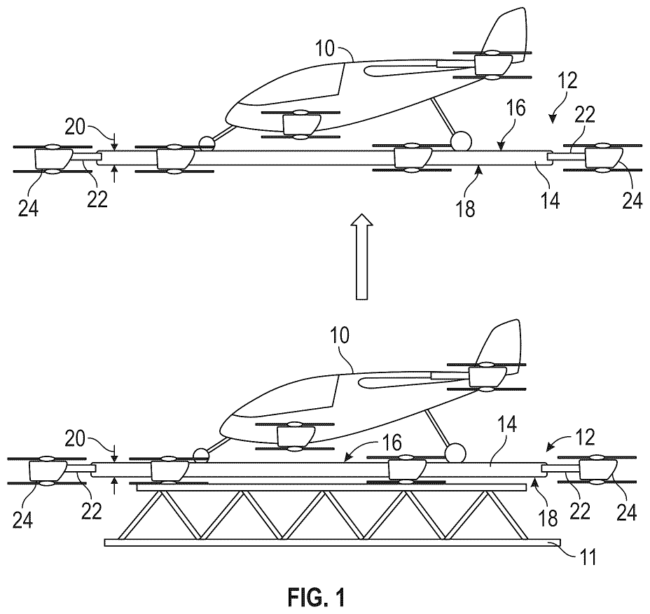

As detailed herein and in FIGS. 1-11, it is contemplated by this disclosure that a platform 12 in operation in accordance with the control strategy 100 is configured to assist in the elevation and acceleration of an eVTOL 10 during a departure cycle (FIG. 2A), i.e., upon take-off, as well as control deceleration of the eVTOL during a return cycle (FIG. 2B), i.e., when landing, in order to reduce the power consumption and reduce battery depletion during such departure and return cycles to ultimately increase the distance the eVTOL 10 can travel before its battery pack 42 must be recharged. In short, the platform 12 is configured to: 1) during an eVTOL 10 departure cycle (FIG. 2A), lift and accelerate the eVTOL 10, at a user acceptable rate, to an initial altitude to begin more efficient cruise flight; 2) provide support to an in-air eVTOL 10, by autonomously ascending to meet the eVTOL at its cruise altitude for temporary landing or receiving a payload; and/or 3) during an eVTOL return cycle (FIG. 2B), autonomously ascend to meet the eVTOL 10 at its cruise altitude and control deceleration of the eVTOL to a landing pad 11 or location. The control strategy 100 detailed herein is operative to coordinate such departure and return cycles to dynamically and safely manage and prioritize landing requests from eVTOLs 10 and prioritize those requests on the basis of the number of available platforms 12, real-time environmental characteristics, and eVTOL characteristics.

With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. An autonomous lift and descension assist platform for an electronic vertical take-off and landing (eVTOL) vehicle, the platform comprising:
a platform substrate having a body, the body further defining:
defining a top surface;
a bottom surface that is radially spaced apart from the top surface by a platform thickness; and
an outer body edge defining an exterior perimeter of the platform substrate;
a plurality of extension portions attached to the platform substrate at the outer body edge of the platform substrate;
a plurality of mobility devices, wherein at least one of the mobility devices is disposed on each of the extension portions;
a landing pad disposed in contact with the top surface of the platform substrate, wherein the landing pad is configured to receive the eVTOL thereon;
a plurality of onboard sensors, wherein the plurality of onboard sensors is disposed in a housing operatively connected to the platform substrate;
a plurality of selectively removable battery packs disposed in contact with the bottom surface of the platform substrate and disposed beneath the landing pad, such that the thickness of the platform substrate extends from the landing pad to the plurality of removable battery packs;
a control unit in fluid communication with the plurality of mobility devices, the onboard sensors, and the plurality of battery packs, the control unit having a non-transitory computer readable medium that stores a first set of computer executable instructions and at least one first processor configured to execute the first set of computer executable instructions embodied on the non-transitory computer readable medium, wherein the first set of computer executable instructions cause the control unit and the processor to send signals to one or more of plurality of mobility devices, the onboard sensors, and the plurality of battery packs, to control the platform.

2. The autonomous lift and descension assist platform of claim 1 wherein the control unit is in fluid communication with:
an onboard computer of the eVTOL, such that the control unit is configured to send and receive signals to the onboard computer of the eVTOL; and
a system server, wherein the system server comprises another computer readable memory that stores a storage database, a knowledge database, a set of computer executable instructions, and another processor configured to execute the computer executable instructions embodied on the non-transitory computer readable medium.

3. The autonomous lift and descension assist platform of claim 2 further comprising a conductive charging pad configured to charge the battery packs when disposed in contact with a power supply.

4. The autonomous lift and descension assist platform of claim 3 wherein the plurality of onboard sensor comprises at least one LIDAR sensor, a GPS unit, an accelerometer, an altitude sensor, an air pressure sensor, a battery temperature sensor, a positioning sensor, at least one gyroscopic sensor, and a vision system.

5. The autonomous lift and descension assist platform of claim 4 wherein the plurality of mobility devices is a plurality of unmanned aerial vehicles (UAVs) configured to allow for the ascension and descension of the platform.

6. The autonomous lift and descension assist platform of claim 4 wherein the plurality of mobility devices is a plurality of adaptive ducted fans configured to allow for the ascension and descension of the platform.

7. The autonomous lift and descension assist platform of claim 4 wherein:
the platform substrate comprises a mesh grate formed of an aluminum material coated with a carbon fiber reinforced polyamide;
the platform substrate comprises a plurality of portions including a first portion, a second portion, a third portion, and a fourth portion, such that each of the first portion, the second portion, the third portion, and the fourth portion are formed in a substantially square shape having a width of about forty-five feet and a length of about forty-five feet; and
the platform substrate thickness is from about two feet to about three feet.

8. The autonomous lift and descension assist platform of claim 4 wherein when the first set of computer executable instructions is executed the control unit further instructs the first processor to:
receive a landing request from the onboard computer of the eVTOL to land on the landing pad of the platform, wherein the landing request includes a plurality of eVTOL characteristics;
evaluate the eVTOL characteristics, evaluate a plurality of environmental conditions with the plurality of onboard sensors, and determine if the platform is a viable landing location for the eVTOL; and
transmitting a decision signal to the onboard computer of the eVTOL.

9. The autonomous lift and descension assist platform of claim 8 wherein when the decision signal indicates that the platform is not a viable landing location for the eVTOL, the first set of computer executable instructions is executed the control unit further instructs the first processor to:
transmit a signal to the eVTOL refusing the landing request; and
transmit a signal to the system server to re-route the eVTOL to an alternate platform.

10. The autonomous lift and descension assist platform of claim 8 wherein when the decision signal indicates that the platform is a viable landing location for the eVTOL, the first set of computer executable instructions is executed the control unit further instructs the first processor to:
organize and prioritize the landing requests received;
determine a priority of the landing request from the eVTOL based on a number of available platforms, eVTOL characteristics, and environmental characteristics; and
schedule landing time for the eVTOL.

11. The autonomous lift and descension assist platform of claim 10 wherein when the set of computer executable instructions is executed the control unit further instructs the processor to re-determine the priority of the landing requests received based on additional requests to land on the landing pad of the platform from other eVTOLs, the number of available platforms, eVTOL characteristics, and environmental characteristics.

12. The autonomous lift and descension assist platform of claim 11 wherein when the set of computer executable instructions is executed the control unit further instructs the processor to reschedule the landing time for the eVTOL.

13. The autonomous lift and descension assist platform of claim 11 wherein when the set of computer executable instructions is executed the control unit further instructs the processor to:
transmit a signal to the eVTOL refusing the landing request; and
transmit a signal to the system server to re-route the eVTOL to an alternate platform.

14. A method of autonomous lift and descension assist for an electronic vertical take-off and landing (eVTOL) vehicle using an autonomous lift and descension assist platform, the method comprising the steps of:
receiving a landing request from an onboard computer of the eVTOL to land on a landing pad of the autonomous lift and descension assist platform, wherein the landing request includes a plurality of eVTOL characteristics;
evaluating each of the eVTOL characteristics and a plurality of environmental conditions and determining if the platform is a viable landing location for the eVTOL based on the evaluation of the eVTOL characteristics and the plurality of environmental conditions; and
transmitting a decision signal to the onboard computer of the eVTOL;
organize and prioritize the landing requests received; and
determine a priority of the landing request from the eVTOL based on number of available platforms, eVTOL characteristics, and environmental characteristics.

15. The method of claim 14 wherein, when the decision signal indicates that the platform is not a viable landing location for the eVTOL, the method further comprises the steps of:
transmitting a signal to the onboard computer of the eVTOL refusing the landing request; and
transmitting a signal to the system server to re-route the eVTOL to an alternate platform.

16. The method of claim 14 wherein, when the decision signal indicates that the platform is a viable landing location for the eVTOL, the method further comprises the step of:
scheduling a landing time for the eVTOL.

17. The method of claim 16 further comprising the step of re-determining the priority of the landing requests received based on additional requests to land on the landing pad of the platform from other eVTOLs, the number of available platforms, eVTOL characteristics, and environmental characteristics.

18. The method of claim 17 further comprising the steps of:
transmitting a signal to the onboard computer of the eVTOL refusing the landing request; and
transmitting a signal to the system server to re-route the eVTOL to an alternate platform.

19. The method of claim 17 further comprising the step of rescheduling the landing time for the eVTOL.

20. The method of claim 19 further comprising the steps of:
receiving a take-off request from the onboard computer of the eVTOL to exit the landing pad of the autonomous lift and descension assist platform;
transmitting a take-off confirmation to the system server;
receiving a plurality of take-off criteria from the system server and transmitting the take-off criteria to the onboard computer of the eVTOL;
orienting the eVTOL in accordance with the take-off criteria; and
transmitting a signal to the onboard computer of the eVTOL clearing the eVTOL for take-off.
